(19) United States
(12) Patent Application Publication
(10) Pub. No.: US 2007/0293605 A1
(43) Pub. Date: Dec. 20, 2007

(54) Biodegradable Composite, Use Thereof and Method for Producing a Biodegradable Block Copolyester-Urethane

(75) Inventors: Hartmut Seliger, Elchingen (DE); Hans Haberlein, Roth (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: UNIVERSITAT ULM, ULM (DE)

(21) Appl. No.: 11/570,220

(22) PCT Filed: Jun. 7, 2005
(86) PCT No.: PCT/EP05/06103

§ 371 Date: Jun. 12, 2007

(30) Foreign Application Priority Data
Jun. 7, 2004 (DE) 10 2004 027 673.0

(51) Int. Cl. C08G 71/00

(52) U.S. Cl. 524/41; 524/35; 524/42

(57) ABSTRACT

The invention relates to a composite system comprising at least one biodegradable block copolyester urethane, at least one filler comprising a polysaccharide and/or derivatives thereof and also possibly further biocompatible additives. Composite systems of this type are used for the production of moulded articles, moulded parts or extrudates. In addition, the invention relates to a method for the production of a biodegradable block copolyester urethane by polyaddition of a polyhydroxy alkanoate diol, a polyester diol of a dicarboxylic acid monoester and a bifunctional isocyanate.

The invention relates to a composite system comprising at least one biodegradable block copolyester urethane, at least one filler comprising a polysaccharide and/or derivatives thereof and also possibly further biocompatible additives. Composite systems of this type are used for the production of moulded articles, moulded parts or extrudates. In addition, the invention relates to a method for the production of a biodegradable block copolyester urethane by polyaddition of a polyhydroxy alkanoate diol, a polyester diol of a dicarboxylic acid monoester and a bifunctional isocyanate.

Poly-(R)-3-hydroxybutyrate (R-PHB) is from an environments standpoint and from the viewpoint of sustainability a virtually ideal polymer material. It is produced from sugar production waste, i.e. from renewable raw materials, by bacterial fermentation on a commercial scale. Under conditions in which plastic materials are normally used, it is stable but can be biologically degraded within weeks to months in the landfill site or by composting methods. R-PHB can be processed thermoplastically and can be readily recycled as a thermoplast. It is biocompatible and can be used as a component of implant materials and as a good substrate for cell growth. Stereoregular organic synthetic components were able to be obtained by degradation of R-PHB.

The R-PHB obtained from bacteria has however unfavourable material properties for many applications. It is brittle and inelastic and the production of transparent films is not possible. The melting point at 177° C. is so high that only a relatively small temperature range for thermoplastic processing is produced up to the incipient decomposition at approx. 210° C. All these disadvantages are produced from the high crystallinity of R-PHB. Finally, often cell fragments remain from the processing of the biological material which disintegrate during the processing, which leads to malodorous smells.

In order to eliminate the difficulties of thermoplastic processing, two paths were adopted above all. Thus on the one hand it was attempted to set low processing temperatures by means of physical measures, in particular by delaying crystallisation. On the other hand, bacteria cultures and substrates were used which enable the production of copolymers, in particular poly-3-hydroxybutyrate-co-3-hydroxy-valerate. In the first case, ageing leads however to secondary crystallisation, i.e. becoming brittle. In the latter case, in fact lowering the melting temperature and increasing the elasticity is achieved but the possibility of controlling the properties by bacterial copolymerisation is provided only within narrow limits.

Starting herefrom, it was the object of the present invention to provide a polymer system which avoids the mentioned disadvantages of the state of the art and provides a polymer material, the elasticity of which is controllable, the material being intended to be completely biodegradable.

This object is achieved by the generic composite system having the characterising features of claim 1 and also the generic method for the production of a biodegradable block copolyester urethane having the characterising features of claim 18. The object is likewise achieved by the accordingly produced moulded articles, moulded parts and extrudates according to claim 21. In claim 22, the use of the composite systems according to the invention is described. The further dependent claims reveal advantageous developments.

According to the invention, a composite system comprising at least one biodegradable block copolyester urethane, at least one filler comprising a polysaccharide and/or derivates thereof and also possibly further biocompatible additives is provided. It is essential for the composite system according to the invention that the block copolyester urethane is formed from a hard segment comprising a polyhydroxy alkanoate diol and also a polyester diol soft segment, starting from a diol and a dicarboxylic acid or hydroxycarboxylic acid and derivates thereof as co-component by cross-linkage with a bifunctional isocyanate.

Preferably the elasticity, strength and tensile elongation of the composite system is adjusted specifically via the quantitative proportion of the block copolyester urethane and of the filler.

The polyhydroxy alkanoate diol used as hard segment is preferably selected from the group poly-3-hydroxybutyrate-diol (PHB-diol) and poly 3-hydroxybutyrate-co-3-hydroxy-valerate-diol (PHB-co-HV-diol).

The production of the hard segment is thereby effected by re-esterification with a diol which is preferably aliphatic, cycloaliphatic, araliphatic and/or aromatic. 1,4-butane diol is used preferably as diol.

The soft segment is produced by re-esterification of a dicarboxylic acid with a diol. The dicarboxylic acid is thereby preferably aliphatic, cycloaliphatic, araliphatic and/or aromatic. Aliphatic, cycloaliphatic, araliphatic and/or aromatic diols are preferred for the re-esterification 1,4-butane diol is hereby particularly preferred.

Preferably poly-butyleneglycol-adipate-diol (PBA-diol) is used as soft segment.

In addition, the block copolyester urethane is constructed from a bifunctional isocyanate which is preferably aliphatic, cycloaliphatic, araliphatic and/or aromatic as cross-linking member. The bifunctional isocyanate is particularly preferred selected from the group tetramethylene diisocyanate, hexamethylene diisocyanate and isophorone diisocyanate.

As biodegradable fillers, fillers based on polysaccharides are used, preferably those from the group starch and derivatives thereof, cyclodextrins and chemical pulp, paper powder and cellulose derivatives, such as cellulose acetates or cellulose ethers. Particularly preferred as celluose derivatives are thereby compounds from the group methylcellulose, ethylcellulose, dihydroxypropylcellulose, hydroxyethylcellulose, hydroxypropylcellulose, hydroxybutylcellulose, methylhydroxybutylcellulose, ethylhydroxybutylcellulose, ethylhydroxyethylcellulose, carboxyalkylcellulose, sulfoalkylcellulose and cyanoethylcellulose.

The filler is preferably a natural product and is used preferably in fibre form.

In addition to the mentioned main components, in addition additives car be contained in the composite system. There are included here preferably biocompatible adhesives, colour pigments or mould-release agents such as talc. Also carbon black can be contained as further additive. Particularly preferred as additives are polyethyleneglycol and/or polyvinylalcohol as biocompatible adhesives.

The composite system is not restricted with respect to the quantitative proportions of the individual components. Preferably the composite system contains between 1 and 90% by weight of the filler, particularly preferred between 1 and 70% by weight. These quantitative data relate to the total composite system.

In a preferred embodiment, the composite system is constructed in layers, a filler layer based on polysaccharides being coated at least in regions on one and/or both sides with the biodegradable block copolyester urethane.

In a further preferred embodiment, the composite system is present as a polymer blend or polymer alloy.

According to the invention, likewise a method for the production of a biodegradable block copolyester urethane by polyaddition of a polyhydroxy alkanoate diol, a diol of a dicarboxylic acid and a bifunctional isocyanate is provided. It is a particular feature of this method that a metallic acetylacetonate is used as catalyst. Preferably metal acetylacetonates of the third main group or of the fourth and seventh subgroup of the periodic table of the elements are used.

It was able to be shown surprisingly that by adding biocompatible catalysts of this type, in contrast to the organotin catalysts used in prior art which represent a significant potential danger because of their toxicity, comparably high product yields were able to be achieved.

An acetylacetonate of aluminium, manganese and/or zirconium is used preferably as catalyst.

The reaction temperature during the polyaddition is thereby not higher than 100° C., in particular not higher than 80° C.

According to the invention, likewise moulded articles, moulded parts and extrudates are provided, which have been produced from a composite system according to one of the claims 1 to 17.

The composite systems produced according to claims 1 to 17 are used for the production of coating materials, foils, films, laminates, moulded articles, moulded parts, extrudates, containers, packaging materials, coating materials and drug administration forms. The application fields for materials of this type are very wide and relate for example to door side coverings and attachment parts in the interior in the automobile industry, seat shells and seat backs of furniture, screw latches, sunken lights in horticulture, golf tees, battery holders in the toy field, protective elements in the packaging field, disposable parts in the building sector or even e.g. Christmas decorations.

Surprisingly, it was also able to be shown that the biodegradable block copolyester urethanes according to the invention have excellent adhesion properties. Hence glass surfaces were painted with solutions of the block copolyester urethanes with chloroform or dioxane. It was hereby established that the thus produced films on the glass surfaces could not be removed without destruction and the glass surfaces were no longer separable from each other. The same phenomenon was observed for aluminium and enamel surfaces.

Hence the block copolyester urethanes according to the invention are outstandingly suitable as adhesive, adhesive tape or other adhesion aids.

The subject according to the invention is intended to be explained in more detail with reference to the subsequent Figures and examples without restricting the latter to the special embodiments shown here.

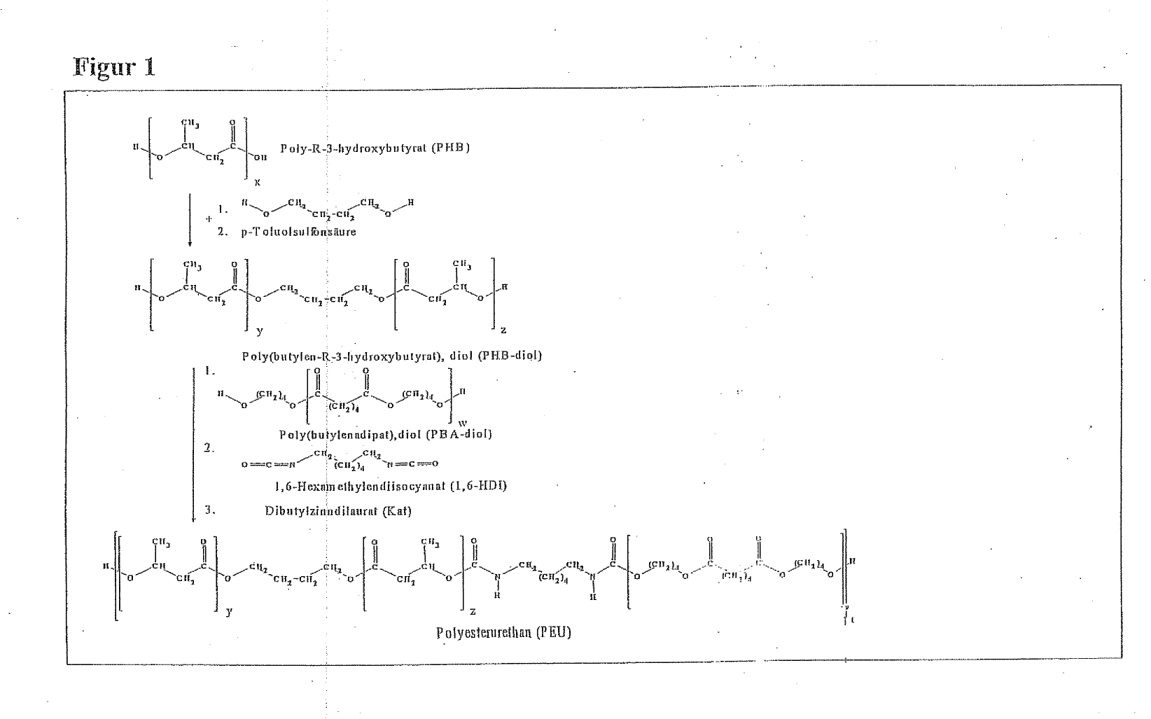

FIG. 1 shows the synthesis diagram for preparing a polyester urethane according to the invention.

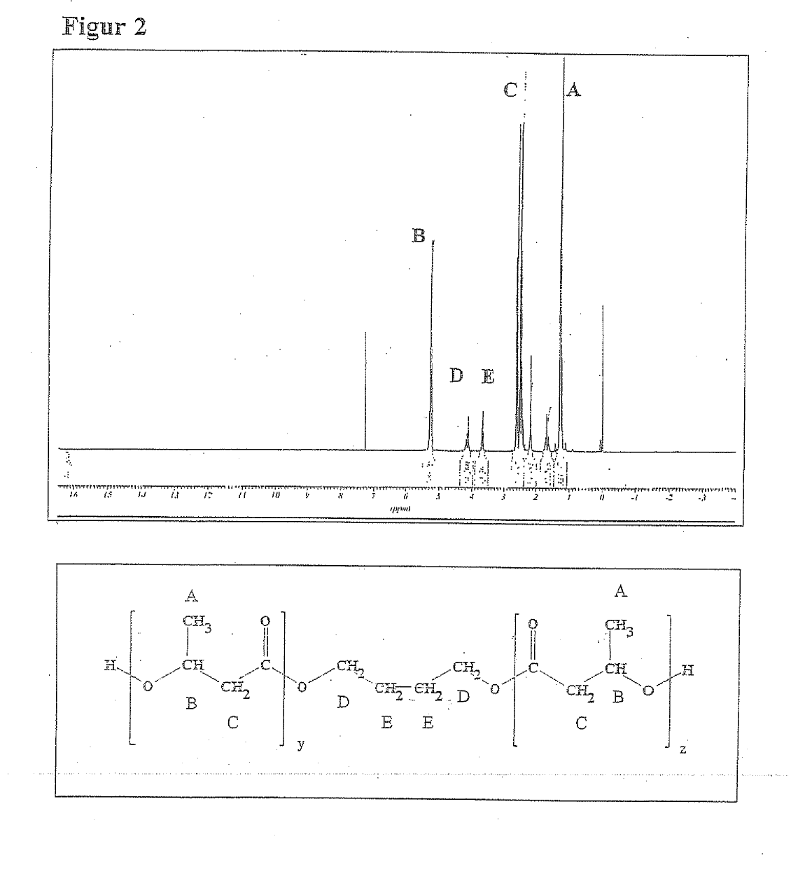

FIG. 2 shows the ¹H nuclear resonance spectrum (400 MHz) of the PHB-diol.

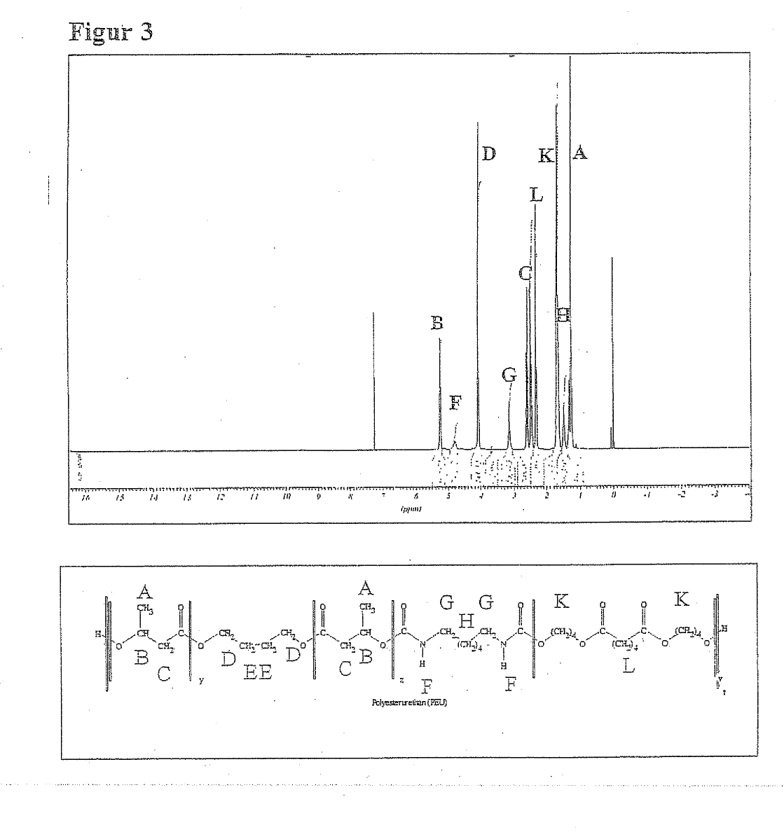

FIG. 3 shows the ¹H nuclear resonance spectrum of polyester urethane 50:50 (400 Mhz).

### EXAMPLE 1

### Production of the Block Copolyester Urethane

The polyester urethane was prepared according to a variant prepared by G. R. Saad (G. K. Saad, Y. J. Lee, H. Seliger, J. Appl. Poly. Sci. 83 (2002) 703-718) which is based on directions by W. Hirt et al. (7, 8). The synthesis is effected in two stages. Bacterial poly-3-hydroxybutyrate from Biomer) is firstly converted in the presence of a catalyst of dibutyltin dilaurate with 1,4-butanediol. After cleaning, the obtained short-chain poly(butylene-R-3-hydroxybutyrate)-diol (PHB-diol) with poly(butyleneadipate)-diol (PBA-diol) as co-component and hexamethylenediisocyanate are polyadded likewise catalytically into polyester urethane.

The synthesis diagram for preparation of the polyester urethane is represented in FIG. 1.

1.1. Preparation of poly(alkylene-(R)-3-hydroxybutyrate)-diol

Poly(butylene-(R)-3-hydroxybutyrate)-diol was produced in various batches. Bacterial PHD was thereby dissolved in chloroform and transesterified at 61° C. with 1,4-butanediol. P-toluenesulfonic acid was used as catalyst. The product was obtained in solid form by means of subsequent precipitation and rewashing.

During the individual tests, different parameters, such as morphology of PHD, solvent quantity, catalyst quantity, agitation time, processing were varied.

Ground and fibrous PHB was used. Under the chosen conditions, PHB was not able to be dissolved completely. Therefore the contents of the flask were slurry-like before the addition of 1,4-butanediol and p-toluenesulfonic acid but were still readily agitatable with heat. With increasing reaction time, the reaction mass became increasingly more mobile but remained cloudy. Furthermore, an almost linear dependency of the reaction time upon the quantity of catalyst could be established.

There were great differences in the precipitation of the chloroform solutions in methanol, diethylether, toluene and cyclohexane. Whereas very fine crystalline precipitates which could be suctioned off and washed only with difficulty were produced with methanol, toluene and cyclohexane, diethylether produced a very clean; coarse crystalline material. The mol weights in contrast differed little. Cyclohexane was subjected to a more precise examination. Independently of the solvent precipitation agent concentration, only fine crystalline product was thereby produced. If the reaction solution is put in place and cyclohexane is added in drops, the precipitation behaves in a completely different manner. After initial cloudiness, the product was present in a very coarse powder form and was able to be filtered just as well as the solids from diethylether. All the solids were present as almost white powder.

The yields were 60 to 94% of the theoretical.

The molecular weights Mᵤ were between 1500 and 5500 g/mol.

The products were examined by means of ¹H nuclear resonance spectroscopy (see FIG. 2).

Further tests showed that chloroform can be replaced without difficulty by dioxane.

In particular the higher boiling point of the dioxane and the higher solubility of the diol component led to a significant reduction in reaction times with identical yields and molecular weights.

The essential differences in reaction control, dependent upon the solvent used, are compiled in the following Table 1 (with ethylene glycol as the dialcohol used).

TABLE 1

| | | | | Reaction |
|---|---|---|---|---|
| Solvent | PHB/solv. | Catalyst | Temperature | time |
| chloroform | 0.20 g/ml | p-toluenesufonic | 61° C. | 10 h |
| | | acid | | |
| dioxane | 0.15 g/ml | sulphuric acid | 90° C. | 2 h |
| | | (98%) | | |

1.2. Preparation of the Polyester Urethanes

After partial, azeotropic distillation of the 1,2-dichloroethane, the polyester urethanes were synthesised by polyaddition of poly(-R-3-hydroxybutyrate)-diol and poly(butyleneadipate)-diol with 1,6-hexamethylene diisocyanate (according to G. R. Saad). Dibutyltin dilaurate was used as catalyst. The polymers were precipitated, washed and dried. The analysis was effected again by GPC and ¹H-NMR spectroscopy. The composition of the products was hereby examined as a function of the mixing ratio of the educts, the distillation quantity of azeotrope, the catalyst quantity, the reaction time, the quantity of 1,6-hexamethylene diisocyanate and the solvent concentration.

FIG. 3 shows the ¹H-NMR spectrum of polyester urethane 50:50 by way of example (400 MHz).

It was shown in further tests that further improvements can be achieved relative to the directions of G. R. Saad.

On the one hand, 1,2-dichloroethane can be replaced by 1,4-dioxane without disadvantages. On the other hand, the organotin catalyst was substituted by different metal acetylacetonates. In particular the zirconium (IV)-acetylacetonate catalyst was distinguished in a positive manner by high activity (reduction in reaction time) and high selectivity (low allophanate formation).

When using the metal acetylacetonates as catalyst, it must be stressed that, in contrast to organotin catalysts with their partially carcinogenic potential, of concern here are biocompatible catalysts. In this way, a reaction system which is based only on biocompatible components, e.g. educts, solvents and catalysts, was surprisingly able to be made available.

For the conversion of PHB-diol and PDA-diol (in the weight ratio 1:1) with equimolar quantities of 1,6-hexamethylenediisocyanate (PEU 50:50) at 75° C., the following results were achieved (Table 2).

TABLE 2

| Catalyst | Molecular weight |
|---|---|
| manganese(II)acetylacetonate | 6300 g/mol |
| aluminium(III)acetylacetonate | 16000 g/mol |
| zirconium(IV)acetylacetonate | 43000 g/mol |

1.3. Production of the Blend of Polyester Urethane and Recycling Material

Cellulose acetate-containing waste from the company EFKA Works, Trossingen was used as recycling material. This waste comprises by weight mainly cellulose triacetate (approx. 83%), paper (approx. 10%) and additives (glue, binders, approx. 7%). As the diagram below shows, the starting material is on the one hand very inhomogeneous and on the other very voluminous. Hence a process was effected, as is also normal in the textile industry, by comminution (cutting blades), and shredding (separators).

Blends of this material were mixed in small quantities (up to 100 g) on a heating plate. Table 3 shows the composition of the blends (small quantity).

TABLE 3

| | |
|---|---|
| Composition PEU | Composition of the blends |

| | | | |
|---|---|---|---|
| 50% PHB-diol | 50% PBA-diol | 75% PEU | 25% CAR |
| 50% PHB-diol | 50% PBA-diol | 50% PEU | 50% CAR |
| 40% PHB-diol | 60% PBA-diol | 75% PEU | 25% CAR |

Very inhomogeneous blends were obtained which were ground for injection moulding (particle size up to 3 mm diameter).

For large quantities (kg scale), the fibres were made parallel in a carding machine to form a web.

This web of fibres was incorporated into the poly(esterurethane) melt by means of heated rollers at temperatures between 120° C. (PEU 50:50) and 140° C. (PEU 40:60).

The following blends were produced on a kg scale (see Table 4).

TABLE 4

| | |
|---|---|
| Composition PEU | Composition of the blends |

| | | | |
|---|---|---|---|
| 50% PHB-diol | 50% PBA-diol | 75% PEU | 25% CAR |
| 40% PHB-diol | 60% PBA-diol | 75% PEU | 25% CAR |
| 40% PHB-diol | 60% PBA-diol | 60% PEU | 40% CAR |

Furthermore 25×12 cm size composite panels with a layer thickness of 3 mm and a weight of approx. 115 g were fabricated from PEU films (from solution in chloroform) and from the fibre web in a heatable platen press at 160° C. Table 5 shows the composition of the blends (moulding compounds).

TABLE 5

| | |
|---|---|
| Composition PEU | Composition of the blends |

| | | | |
|---|---|---|---|
| 50% PHB-diol | 50% PBA-diol | 30% PEU | 70% CAR |
| 40% PHB-diol | 60% PBA-diol | 30% PEU | 70% CAR |

1.4. Processing of the Samples by Injection Moulding

Blends of polyester urethane and cellulose acetate recycling material were examined in 50 g batches in a plunger injection machine with respect to their processibility.

Whilst the blends with 25% to 40% fibre proportion could be processed at 130 to 170° C., this was no longer possible with a fibre content of 50%. In the case of the samples which contained PEU 40:60, it was in addition difficult to remove the moulded parts from the cooled mould. Pure PEU samples barely showed this phenomenon on the other hand. Therefore the processing temperatures were lowered to 80 to 100° C. (softening points of the blends).

On a 1 kg scale, the short fibre granulates were injected in an injection moulding machine with a conveyor screw. Sample bodies were produced at different temperature intervals with and without addition of mould-release agent (talc).

Table 6 shows a compilation of the composite systems according to the invention which were produced by injection moulding.

TABLE 6

| PEU | | | | Temperature | |
|---|---|---|---|---|---|
| PHB-diol | PBA-diol | CAR | Talc | range | Workpiece |
| 50% | 50% | 25% | − | 150-170° C. | Specimen |
| 50% | 50% | 25% | + | 150-170° C. | Specimen |
| 40% | 60% | 25% | + | 150-170° C. | Specimen |
| 50% | 50% | 25% | − | 80-100° C. | Specimen |
| 40% | 60% | 25% | − | 80-100° C. | Specimen |
| 50% | 50% | 25% | − | 150-170° C. | DIN body |
| 40% | 60% | 40% | − | 150-170° C. | DIN body |

1.5. Mechanical Properties

Tensile, elongation, bending and impact strength measurements were implemented. Table 7 shows the relevant mechanical properties.

TABLE 7

| | Modulus of | Tensile | Tensile |
|---|---|---|---|
| | elasticity | strength | elongation |
| Sample name | (N/mm²) | (N/mm²) | (%) |
| PEU50: 50 | 1966 | 14.8 | 3.1 |
| CAR70% P | (154) | (1.22) | (0.5) |
| (Standard deviation) | | | |
| PEU50: 50 | 577.2 | 13.1 | 7.2 |
| CAR25% S | (33.6) | (0.2) | (0.6) |
| (Standard deviation) | | | |
| PEU40: 60 | 2033 | 16.1 | 2.12 |
| CAR70% P | (172) | (1.42) | (0.45) |
| (Standard deviation) | | | |
| PEU40: 60 | 496 | 13.1 | 6.7 |
| CAR40% S | (108) | (0.8) | (0.5) |
| (Standard deviation) | | | |

| | Bending | Bending | Bending | Impact |
|---|---|---|---|---|
| | strength | elongation | modulus | strength |
| Sample name | (N/mm²) | (%) | (N/mm²) | (mJ/mm²) |
| PEU50: 50 | 27.9 | | 2180 | 15.6 |
| CAR70% P | | | | |
| (Standard | (2.23) | | (194) | (1.9) |
| deviation) | | | | |
| PEU50: 50 | 21.9 | 8.8 | 532.7 | 28.4 |
| CAR25% S | | | | |
| (Standard | (0.4) | (0.4) | (9.5) | (2.7) |
| deviation) | | | | |
| PEU40: 60 | 26.1 | | 1763 | 16.4 |
| CAR70% P | | | | |
| (Standard | (0.2) | | (107) | (1.96) |
| deviation) | | | | |
| PEU40: 60 | 16.8 | 7.9 | 444 | 26.0 |
| CAR40% S | | | | |
| (Standard | (1.2) | (0.9) | (14.7) | (3.7) |
| deviation) | | | | |

1. Composite system comprising at least one biodegradable block copolyester urethane, at least one filler comprising a polysaccharide and/or derivatives thereof and also possibly further biocompatible additives,
characterised in that the block copolyester urethane being formed from a hard segment comprising a polyhydroxy alkanoate diol and also a polyester diol soft segment, starting from a diol and a dicarboxylic acid or hydroxycarboxylic acid and derivatives thereof as co-component by cross-linkage with a bifunctional isocyanate.

2. Composite system according to claim 1,
characterised in that the elasticity, strength and tensile elongation of the composite system can be adjusted specifically via the quantitative proportion of block copolyester urethane and of filler.

3. Composite system according to one of the preceding claims,
characterised in that the polyhydroxy alkanoate diol is a poly-3-hydroxybutyrate-diol (PHB-diol) or a poly-3-hydroxybutyrate-co-3-hydroxy-valerate-diol (PHB-co-HV-diol).

4. Composite system according to one of the preceding claims,
characterised in that the diol is aliphatic, cycloaliphatic, araliphatic and/or aromatic.

5. Composite system according to the preceding claim,
characterised in that the diol is 1,4-butane diol.

6. Composite system according to one of the preceding claims,
characterised in that the dicarboxylic acid is aliphatic, cycloaliphatic, araliphatic and/or aromatic.

7. Composite system according to the preceding claim,
characterised in that the diol of the dicarboxylic acid is poly-butyleneglycol-adipate-diol (PBA-diol).

8. Composite system according to one of the preceding claims,
characterised in that the bifunctional isocyanate is aliphatic, cycloaliphatic, araliphatic and/or aromatic.

9. Composite system according to the preceding claim,
characterised in that the bifunctional isocyanate is selected from the group tetramethylene diisocyanate, hexamethylene diisocyanate and isophorone diisocyanate.

10. Composite system according to one of the preceding claims,
characterised in that the filler is selected from the group cellulose derivatives thereof as cellulose acetates, starch and derivatives thereof, chemical pulp and paper powder.

11. Composite system according to one of the preceding claims,
characterised in that the cellulose derivatives are cellulose acetates and/or cellulose ethers, in particular selected from the group methylcellulose, ethylcellulose, dihydroxypropylcellulose, hydroxyethylcellulose, hydroxypropylcellulose, hydroxybutylcellulose, methylhydroxybutylcellulose, ethylhydroxybutylcellulose, ethylhydroxyethylcellulose, carboxyalkylcellulose, sulfoalkylcellulose and cyanoethylcellulose.

12. Composite system according to one of the preceding claims,
characterised in that the filler is used in fibre form.

13. Composite system according to one of the preceding claims,
characterised in that biocompatible adhesives, colour pigments, mould-release agents such as talc and/or carbon black are contained as additives.

14. Composite system according to the preceding claim,
characterised in that polyethyleneglycol and/or polyvinylalcohol are contained as additives

15. Composite system according to one of the preceding claims,
characterised in that the composite system contains between 1 and 90% by weight, in particular between 1 to 70% by weight, relative to the total composite system, of the filler.

16. Composite system according to one of the preceding claims,
characterised in that the composite system is constructed in layers, comprising a filler layer which is coated with the biodegradable block copolyester urethane.

17. Composite system according to one of the claims 1 to 13,
characterised in that the composite system is a polymer blend or a polymer alloy.

18. Method for the production of a biodegradable composite block copolyester urethane according to one of the claims 1 to 17, by polyaddition of a polyhydroxy alkanoate diol, a polyester diol of a dicarboxylic acid or hydroxycarboxylic acid and a bifunctional isocyanate,
characterised in that
a metal actylacetonate is used as a catalyst.

19. Method according to claim 18,
characterised in that a metal acetylacetonate of the 3rd main group or of the 4^{th} or 7^{th} subgroup, in particular of Al, Mn and/or Zr, is used.

20. Method according to one of the claims 18 or 19,
characterised in that the reaction temperature of the polyaddition is not higher than 100° C., in particular not higher than 80° C.

21. Moulded articles, moulded parts and extrudates produced from a composite system according to one of the claims 1 to 17.

22. Use of the composite systems according to one of the claims 1 to 17 for the production of coating materials, foils, films, laminates, moulded articles, containers, packaging materials, moulded parts, extrudates, coating materials and drug administration forms.

23. Use of the composite systems according to claim 22 as coating material for paper or starch and also as material for reinforced adhesive layers.

24. Use of the composite systems according to claim 22 as packaging material for foodstuffs.

25. Use of the composite systems according to claim 22 in the form of bags, carrier bags and covers.

26. Use of the composite systems according to claim 22 for medical implants or in galenics in the form of tablets, capsules or suppositories.
